(19) United States
(12) Patent Application Publication
(10) Pub. No.: US 2014/0152915 A1
(43) Pub. Date: Jun. 5, 2014

(54) TOUCH PANEL

(71) Applicants: Chia-Ching Lu, Taichung City (TW); Kuo-Chang Su, Tainan City (TW); Chen-Hao Su, Taichung City (TW); Cheng-Yen Yeh, Taichung City (TW); Yu-Ting Chen, Taoyuan County (TW)

(72) Inventors: Chia-Ching Lu, Taichung City (TW); Kuo-Chang Su, Tainan City (TW); Chen-Hao Su, Taichung City (TW); Cheng-Yen Yeh, Taichung City (TW); Yu-Ting Chen, Taoyuan County (TW)

(73) Assignee: WINTEK CORPORATION, Taichung City (TW)

(21) Appl. No.: 14/093,032

(22) Filed: Nov. 28, 2013

(30) Foreign Application Priority Data
Nov. 30, 2012 (TW) 101145180

(51) Int. Cl. G06F 1/16

(52) U.S. Cl. CPC G06F 1/1643
USPC 349/12

(57) ABSTRACT

A touch panel includes a substrate, a plurality of first and second conductive series, and a plurality of first and second auxiliary electrodes. The first and the second conductive series are disposed alternately on the substrate and located on a light-transmission area of the substrate. A portion of each of the first and second conductive series extends to a peripheral area of the substrate. The first and the second auxiliary electrodes are disposed on the peripheral area. The first auxiliary electrodes connect to the portion of the first conductive series extending to the peripheral area and generate capacitive sensing with the portion of the second conductive series located on the peripheral area. The second auxiliary electrodes connect to the portion of the second conductive series extending to the peripheral area and generate capacitive sensing with the portion of the first conductive series located on the peripheral area.

### CROSS-REFERENCE TO RELATED APPLICATION

This application claims the priority benefit of Taiwan application serial no. 101145180, filed on Nov. 30, 2012. The entirety of the above-mentioned patent application is hereby incorporated by reference herein and made a part of this specification.

### TECHNICAL FIELD

The disclosure relates to a touch panel, and particularly relates to a capacitive touch panel.

### BACKGROUND

Generally speaking, a capacitive touch panel includes a plurality of first conductive series extending along X-axis and a plurality of second conductive series extending along Y-axis, wherein each of the first and second conductive series has a plurality of sensing pads connected in series.

However, in the conventional design of the peripheral of capacitive touch panels, only a small portion of the sensing pads extend from the light-transmission area to the peripheral area. Thus, when a touching object (e.g. a finger) touches the boundary between the light-transmission area and the peripheral area, an interaction between the touching object and the sensing pads is significantly reduced, rendering incorrect identification to location by the controller when computing the coordinates of the touched point due to insufficient information.

### SUMMARY

The disclosure provides a touch panel that increases capacitance variance in a peripheral area by disposing an auxiliary electrode, thereby improving the touch performance of the touch panel.

The disclosure provides a touch panel, including a substrate, a plurality of first conductive series, a plurality of second conductive series, a plurality of first auxiliary electrodes, and a plurality of second auxiliary electrodes. The substrate has a light-transmission area and a peripheral area surrounding the light-transmission area. The first conductive series are disposed on the substrate and located on the light-transmission area, wherein a portion of the first conductive series extends to the peripheral area. The second conductive series are disposed on the substrate and located on the light-transmission area, wherein a portion of the second conductive series extends to the peripheral area, and the second conductive series are arranged interlacedly with the first conductive series. The first auxiliary electrodes are disposed on the peripheral area of the substrate. The first auxiliary electrodes connect to a portion of the first conductive series extending to the peripheral area and generate capacitive sensing with a portion of the second conductive series on the peripheral area. The second auxiliary electrodes are disposed on the peripheral area of the substrate. The second auxiliary electrodes connect to a portion of the second conductive series extending to the peripheral area and generate capacitive sensing with a portion of the first conductive series on the peripheral area.

The disclosure provides a touch panel including a substrate, a plurality of electrode sets, a plurality of first auxiliary electrodes, and a plurality of second auxiliary electrodes. The substrate has a light-transmission area and a peripheral area surrounding the light-transmission area. The electrode sets are disposed on the light-transmission area and the peripheral area. Each of the electrode sets includes a plurality of first electrodes, and a second electrode. The second electrode is disposed beside the first electrodes. The first auxiliary electrodes are disposed on the peripheral area of the substrate. The first auxiliary electrodes connect to the first electrodes extending to the peripheral area and generate capacitive sensing with the second electrode in the same electrode set on the peripheral area. The second auxiliary electrodes are disposed on the peripheral area of the substrate. The second auxiliary electrodes connect to the second electrodes extending to the peripheral area and generate capacitive sensing with the first electrodes in the same electrode set on the peripheral area.

In view of the foregoing, since the touch panel of the disclosure is designed with the first and second auxiliary electrodes, the first auxiliary electrodes are allowed to generate capacitive sensing with the second conductive series on the peripheral area, and the second auxiliary electrodes are allowed to generate capacitive sensing with the first conductive series on the peripheral area. In this way, an area with mutual capacitance of the peripheral area is allowed to effectively increase to facilitate capacitance variance, thereby generally increasing touching performance of the touch panel.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a touch panel according to an embodiment of the disclosure.

FIG. 2 is a schematic view of a touch panel according to another embodiment of the disclosure.

FIG. 3 is a schematic view of a touch panel according to still another embodiment of the disclosure.

FIGS. 4A to 4C are schematic views of the auxiliary electrode of the disclosure.

### DETAILED DESCRIPTION OF DISCLOSED EMBODIMENTS

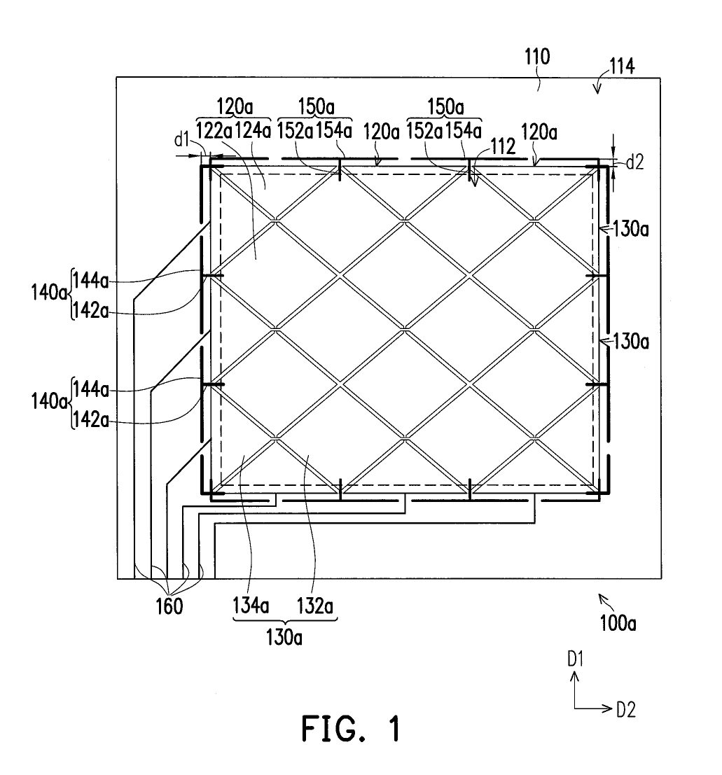

Referring to FIG. 1, in this embodiment, a touch panel 100a includes a substrate 110, a plurality of first conductive series 120a, a plurality of second conductive series 130a, a plurality of first auxiliary electrodes 140a, and a plurality of second auxiliary electrodes 150a. Specifically, the substrate 110 has a light-transmission area 112 and a peripheral area 114 surrounding the light-transmission area 112. The first conductive series 120a and the second conductive series 130a are disposed on the substrate 110 and located on the light-transmission area 112, wherein a portion of the first conductive series 120a and a portion of the second conductive series 130a respectively extend to the peripheral area 114. The second conductive series 130a are arranged interlacedly with the first conductive series 120a. The first auxiliary electrodes 140a are disposed on the peripheral area 114 of the substrate 110.

In this embodiment, each of the first conductive series 120a includes a plurality of first electrodes 122a and 124a, each of the second conductive series 130a includes a plurality of second electrodes 132a and 134a, wherein the first electrodes 122a and 124a are connected in series along a first direction D1, and the second electrodes 132a and 134a are connected in series along a second direction D2. Here, an included angle of the first direction D1 and the second direction D2 is substantially 90 degrees. In other embodiments not shown herein, the included angle of the first direction D1 and the second direction D2 may be other angles not equal to zero. It should be noted that in this embodiment, as shown in FIG. 1, the first electrodes 122a and the second electrodes 132a are implemented in a diamond shape, and the first electrodes 124a and the second electrodes 134a are implemented in a triangle shape. Naturally, in other embodiments not shown herein, the shape of the electrodes may not be limited. Namely, the electrodes may be in shape of a stripe, a rectangle, a triangle, a circle, an ellipse, other polygons, or a combination thereof.

The first auxiliary electrodes 140a connect to the first electrodes 122a extending to the peripheral area 114 and generate capacitive sensing with the second electrodes 134a on the peripheral area 114, and the second auxiliary electrodes 150a connect to the second electrodes 132a extending to the peripheral area 114 and generate capacitive sensing with the first electrodes 124a on the peripheral area 114. The first auxiliary electrodes 140a respectively keep a first distance d1 from the second electrodes 134a on the peripheral area 114, and the second auxiliary electrodes 150a respectively keep a second distance d2 from the first electrodes 124a on the peripheral area 114. Each of the first auxiliary electrodes 140a has a first connecting part 142a and a first extending part 144a, wherein the first connecting part 142a connects to one of the first electrodes 122a corresponding to the first connecting part 142a, the first extending part 144a extends in a direction identical to the first direction D1, and the first extending part 144a generates capacitive sensing with the second electrodes 134a of two adjacent rows of the second conductive series 130a. Similarly, each of the second auxiliary electrodes 150a has a second connecting part 152a and a second extending part 154a, wherein the second connecting part 152a connects to one of the second electrodes 132a corresponding to the second connecting part 152a, the second extending part 154a extends in a direction identical to the second direction D2, and the second extending part 154a generates capacitive sensing with the first electrodes 124a of two adjacent rows of the first conductive series 120a. Here, the first distance d1 and the second distance d2 are between 5 micrometers and 150 micrometers respectively, for example. In this embodiment, the first auxiliary electrodes 140a and the second auxiliary electrodes 150a at corner cross each other without being electrically connected. When manufacturing the first auxiliary electrodes 140a and the second auxiliary electrodes 150a at corner, an insulating layer may be disposed between the first auxiliary electrode 140a and the second auxiliary electrode 150a to avoid electrical connection between the first auxiliary electrode 140a and the second auxiliary electrode 150a. In addition, in other embodiments, the the first auxiliary electrodes 140a and the second auxiliary electrodes 150a may not be disposed at corner.

Moreover, to connect the first conductive series 120a and the second conductive series 130a to a driving circuit (not shown) or an external circuit (not shown), the touch panel 100a further include a plurality of transmission wires 160, wherein the transmission wires 160 are disposed on the substrate 110 and are respectively electrically connected with the first conductive series 120a and the second conductive series 130a. In addition, a material of the substrate 110 in this embodiment may be plastics or glass, for example, and the material of the substrate 110 is not limited to a flexible or inflexible material.

Since the touch panel 100a in this embodiment is designed with the first auxiliary electrodes 140a and the second auxiliary electrodes 150a, the first auxiliary electrodes 140a are allowed to generate capacitive sensing with the second electrodes 134a of the second conductive series 130a on the peripheral area 114, and the second auxiliary electrodes 150a are allowed to generate capacitive sensing with the first electrodes 124a of the first conductive series 120a on the peripheral area 114, an area with mutual capacitance of the peripheral area 114 of the substrate 110 is allowed to effectively increase to facilitate capacitance variance, thereby generally increasing touching performance of the touch panel 110a.

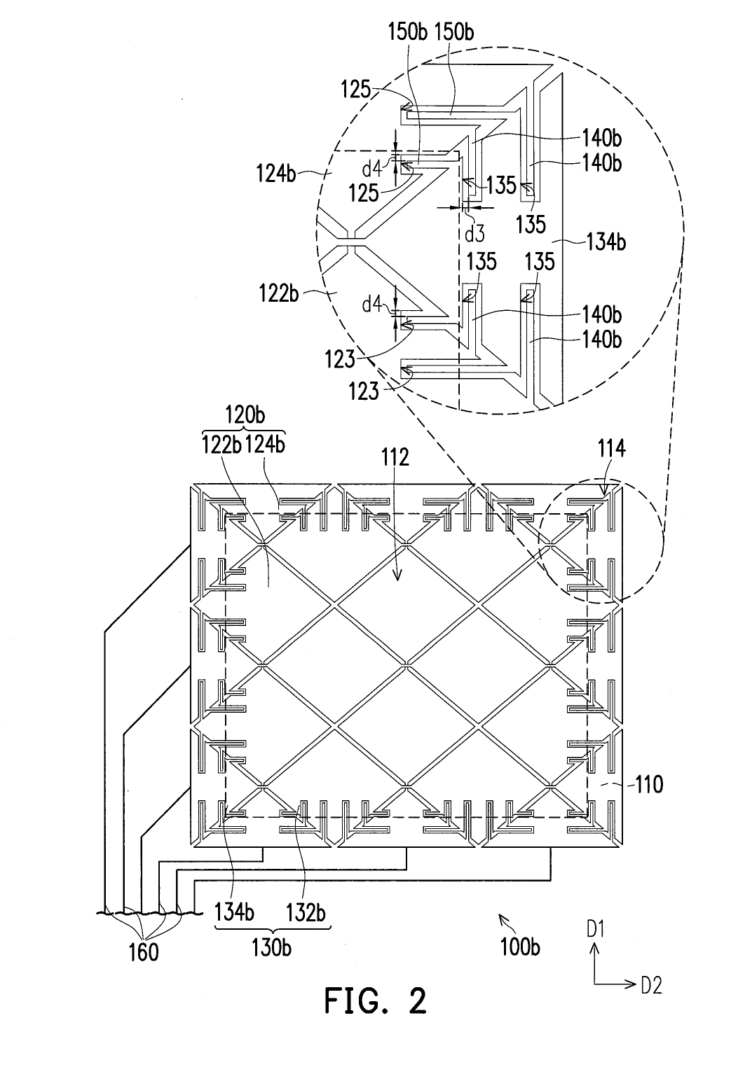

Referring to FIG. 2, the reference numerals and part of the contents of the embodiment above are used in this embodiment as well. A touch panel 100b in this embodiment mainly differs from the touch panel 100a of the embodiment above in that first electrodes 122b and 124b on the peripheral area 114 respectively have at least one openings 123 and 125 (e.g. four openings as shown in FIG. 2). Second electrodes 134b on the peripheral area 114 respectively have at least one second opening 135 (e.g. four openings as shown in FIG. 2). The first auxiliary electrodes 140b respectively extend to the second openings 135 of the second electrodes 134b and respectively keep a first distance d3 from inner walls of the second openings 135, and the second auxiliary electrodes 150b respectively extend to the first openings 123 and 125 of the first electrodes 122b and 124b and respectively keep a second distance d4 from inner walls of the first openings 123 and 125 of the first electrodes 122b and 124b. Here, the first distance d3 and the second distance d4 are between 5 micrometers and 150 micrometers respectively, for example. The first auxiliary electrodes 140b extend in a direction identical to the first direction D1, and the second auxiliary electrodes 150b extend in a direction identical to the second direction D2.

Since the first auxiliary electrodes 140b connect to the first electrodes 122b and 124b extending to the peripheral area 114 and generate capacitive sensing with the second electrodes 134b on the peripheral area 114, and the second auxiliary electrodes 150b connect to the second electrodes 134b extending to the peripheral area 114 and generate capacitive sensing with the first electrodes 122b and 124b on the peripheral area 114, disposing the first auxiliary electrodes 140b and the second auxiliary electrodes 150b allows an effective increase in an area with mutual capacitance of the peripheral area 114 of the substrate 110 to facilitate capacitance variance, thereby generally increasing touching performance of the touch panel 110b.

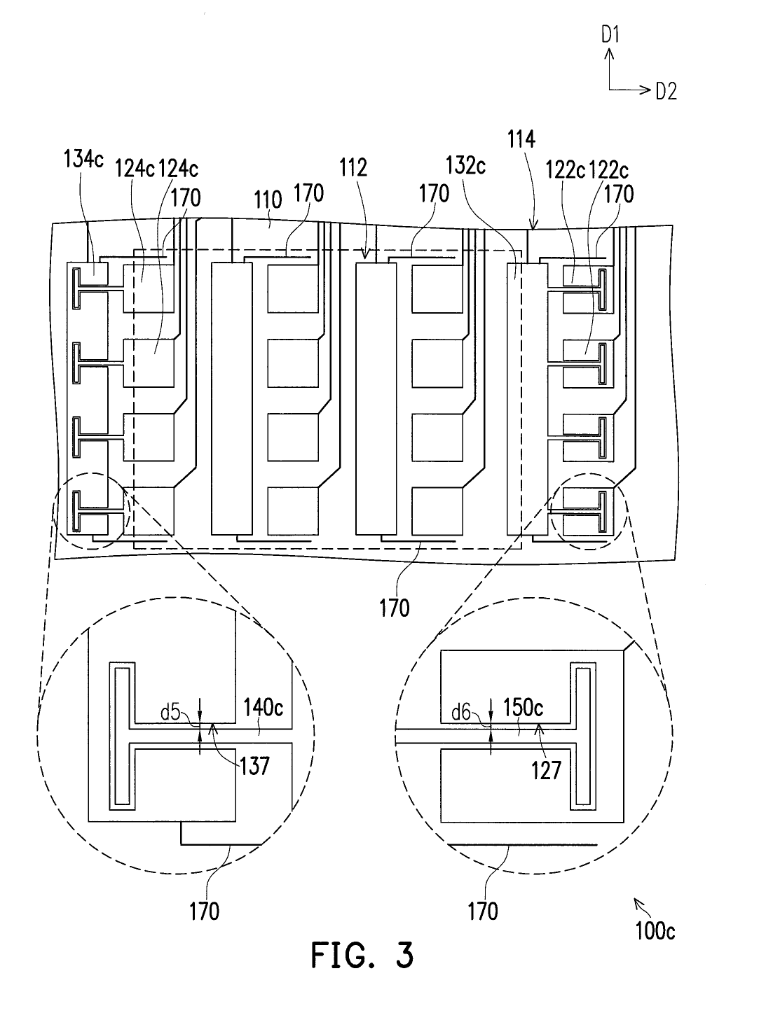

Referring to FIG. 3, a touch panel 100c in this embodiment includes a substrate 110, a plurality of electrode sets, a plurality of first auxiliary electrodes 140c, and a plurality of second auxiliary electrodes 150c. The substrate 110 has a light-transmission area 112 and a peripheral area 114 surrounding the light-transmission area 112. The electrode sets are disposed on the light-transmission area 112 and the peripheral area 114. Each of the electrode sets includes a plurality of first electrodes 122c (or 124c), and a second electrode 132c (or 134c). Here, the first electrodes 122c and 124c are arranged sequentially along the first direction D1, and the second electrodes 132c and 134c are strip electrodes extending along the first direction D1.

As shown in FIG. 3, four first electrodes 122c (or 124c) are disposed beside each of the second electrodes 132c (or 134c), and the stripe-shaped second electrodes 132c and 134c are arranged alternately with the first electrodes 122c and 124c along the second direction D2. The first electrodes 122c on the peripheral area 114 respectively have a first opening 127, and the second electrodes 134c on the peripheral area 114 have a plurality of second openings 137. The first auxiliary electrodes 140c and the second auxiliary electrodes 150c are disposed on the peripheral area 114 of the substrate 110. The first auxiliary electrodes 140c respectively extend to the second openings 137 of the second electrodes 134c and respectively keep a first distance d5 from inner walls of the second openings 137, and the second auxiliary electrodes 150c respectively extend to the first openings 127 of the first electrodes 122c and respectively keep a second distance d6 from inner walls of the first openings 127 of the first electrodes 122c. Here, the first distance d5 and the second distance d6 are between 5 micrometers and 150 micrometers respectively, for example. The first auxiliary electrodes 140c connect to the first electrodes 124c extending to the peripheral area 114 and generate capacitive sensing with the second electrode 134c in the same electrode set on the peripheral area 114. The second auxiliary electrodes 150c connect to the second electrodes 132c extending to the peripheral area 114 and generate capacitive sensing with the first electrodes 122c in the same electrode set on the peripheral area 114.

In addition, the touch panel 100c in this embodiment may further include a plurality of third auxiliary electrodes 170, wherein the third auxiliary electrodes 170 are disposed on the light-transmission area 112 and the peripheral area 114 of the substrate 110. As shown in FIG. 3, two opposite ends of the second electrode 132c (or 134c) in each of the electrode sets are respectively connected to one of the third auxiliary electrodes 170, and the third auxiliary electrodes 170 extend to the first electrodes 122c (or 124c) in the same electrode set and generate capacitive sensing with the first electrodes 122c (or 124c). Here, the third auxiliary electrodes 170 is in an L-shape, for example.

Since the first auxiliary electrodes 140c generate capacitive sensing with the second electrodes 134c on the peripheral area 114, and the second auxiliary electrodes 150c generate capacitive sensing with the first electrodes 122c, disposing the first auxiliary electrodes 140c and the second auxiliary electrodes 150c effectively increases an area with mutual capacitance of the peripheral area 114 of the substrate 110 to facilitate capacitance variance, thereby generally increasing touching performance of the touch panel 100c. In addition, the third auxiliary electrodes 170 connecting to the second electrodes 132c (or 134c) extend to the first electrodes 122c (or 124c) in the same electrode set and generate capacitive sensing with the first electrodes 122c (or 124c). Therefore, disposing the third auxiliary electrodes 170 may increase an area with mutual capacitance on the light-transmission area 112 and the peripheral area 114 of the substrate 110 to facilitate capacitance variance.

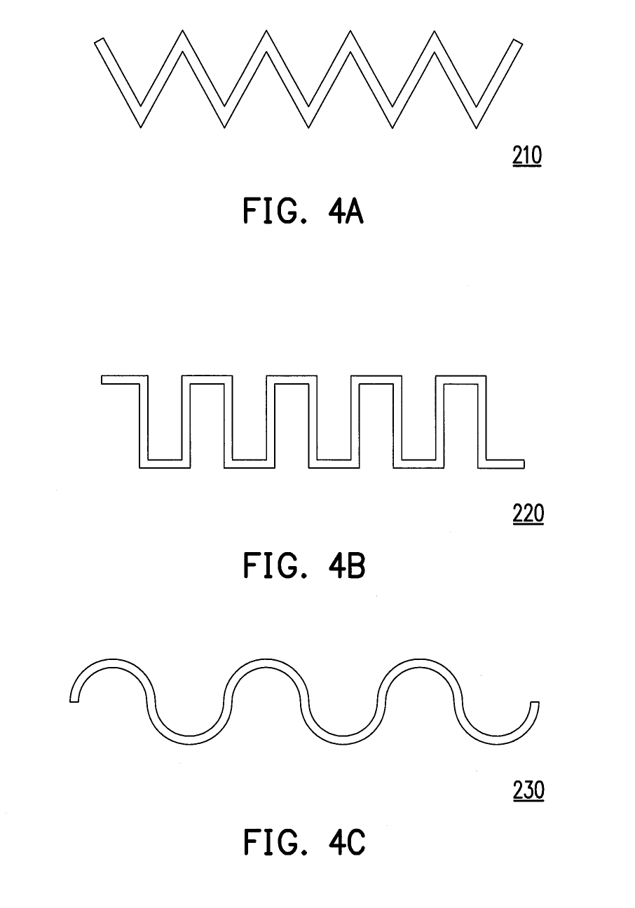

It should be noted that the disclosure does not limit on structural configurations of the first and second auxiliary electrodes. Although the first and second auxiliary electrodes described herein are implemented as stripe auxiliary electrodes, other conventional structural designs that also render an equivalent increase of capacitance variance also belong to the applicable technical solutions of the disclosure and do not depart from the protection scope of the disclosure. For example, as shown in FIGS. 4A to 4C, auxiliary electrodes 210, 220, and 230 may have a zigzag or meander structure, wherein the auxiliary electrode 210 is formed of a plurality of V-shaped patterns, for example, the auxiliary electrode 220 are formed of a plurality of L-shaped and reversed L-shaped patterns, for example, and the auxiliary electrode 230 is formed of a plurality of arc-shaped patterns, for example.

In addition, the disclosure does not limit on disposing positions and configurations of the first conductive series and the second conductive series. For example, the design of the first and second auxiliary electrodes of the disclosure may be applied in a touch panel having a double-layer electrode structure or a touch panel formed of two substrates. In other words, the design of the first and second auxiliary electrodes described in the embodiments above may also be chosen for other embodiments not shown herein. People skilled in the art may refer to the description of the embodiments above and choose the elements based on the practical needs, so as to achieve the desired technical effect.

In view of the foregoing, since the touch panel of the disclosure is designed with the first and second auxiliary electrodes, the first auxiliary electrodes are allowed to generate capacitive sensing with the second conductive series on the peripheral area, and the second auxiliary electrodes are allowed to generate capacitive sensing with the first conductive series on the peripheral area. In this way, an area with mutual capacitance of the peripheral area is allowed to effectively increase to facilitate capacitance variance, thereby generally increasing touching performance of the touch panel. In addition, the first and second auxiliary electrodes may respectively be disposed on the same layer with the first and second conductive series. Namely, the touch panel of the disclosure may increase capacitance variance on the peripheral area without requiring an additional manufacturing process.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A touch panel, comprising:
a substrate, having a light-transmission area and a peripheral area surrounding the light-transmission area;
a plurality of first conductive series, disposed on the substrate and located on the light-transmission area, wherein a portion of the first conductive series extends to the peripheral area;
a plurality of second conductive series, disposed on the substrate and located on the light-transmission area, wherein a portion of the second conductive series extends to the peripheral area, and the second conductive series are arranged interlacedly with the first conductive series;
a plurality of first auxiliary electrodes, disposed on the peripheral area of the substrate, wherein the first auxiliary electrodes connect to the portion of the first conductive series extending to the peripheral area and generate capacitive sensing with the portion of the second conductive series on the peripheral area; and
a plurality of second auxiliary electrodes, disposed on the peripheral area of the substrate, wherein the second auxiliary electrodes connect to the portion of the second conductive series extending to the peripheral area and generate capacitive sensing with the portion of the first conductive series on the peripheral area.

2. The touch panel as claimed in claim 1, wherein each of the first conductive series comprises a plurality of first electrodes, each of the second conductive series comprises a plurality of second electrodes, the first electrodes are connected in series along a first direction, the second electrodes are connected in series along a second direction, the first auxiliary electrodes connect to the first electrodes extending to the peripheral area and generate capacitive sensing with the second electrodes on the peripheral area, and the second auxiliary electrodes connect to the second electrodes extending to the peripheral area and generate capacitive sensing with the first electrodes on the peripheral area.

3. The touch panel as claimed in claim 2, wherein the first auxiliary electrodes extend in a direction identical to the first direction, and the second auxiliary electrodes extend in a direction identical to the second direction.

4. The touch panel as claimed in claim 2, wherein each of the first electrodes on the peripheral area has at least one first opening and corresponds to one second auxiliary electrode extending to the corresponding first opening with a second distance from an inner wall of the corresponding first opening to a periphery of the corresponding second auxiliary electrode, and each of the second electrodes on the peripheral area has at least one second opening and corresponds to one first auxiliary electrode extending to the corresponding second opening with a first distance from an inner wall of the corresponding second opening to a periphery of the corresponding first auxiliary electrode.

5. The touch panel as claimed in claim 4, wherein the first distance and the second distance are between 5 micrometers and 150 micrometers respectively.

6. The touch panel as claimed in claim 2, wherein each of the first auxiliary electrodes having a first connecting part connecting to one of the first electrodes and a first extending part extending in a direction identical to the first direction, and each of the second auxiliary electrodes having a second connecting part connecting to one of the second electrodes and a second extending part extending in a direction identical to the second direction.

7. The touch panel as claimed in claim 6, wherein having a plurality of first distance between each the corresponding first extending part and a peripheral of each corresponding second electrode, and. having a plurality of second distance between each the corresponding second extending part and a peripheral of each corresponding the first electrode.

8. The touch panel as claimed in claim 7, wherein the first distance and the second distance are respectively between 5 micrometers and 150 micrometers.

9. The touch panel as claimed in claim 1, further comprising a plurality of transmission wires disposed on the substrate and each of the transmission wires connects with at least one of the first conductive series or at least one of the second conductive series.

10. A touch panel, comprising:
a substrate, having a light-transmission area and a peripheral area surrounding the light-transmission area;
a plurality of electrode sets, disposed on the light-transmission area and the peripheral area, wherein each of the electrode sets comprising:
a plurality of first electrodes; and
a second electrode, disposed beside the first electrodes;
a plurality of first auxiliary electrodes, disposed on the peripheral area of the substrate, wherein the first auxiliary electrodes connect to the first electrodes extending to the peripheral area and generate capacitive sensing with the second electrode in the same electrode set on the peripheral area; and
a plurality of second auxiliary electrodes, disposed on the peripheral area of the substrate, wherein the second auxiliary electrodes connect to the second electrode extending to the peripheral area and generate capacitive sensing with the first electrodes in the same electrode set on the peripheral area.

11. The touch panel as claimed in claim 10, wherein each of the first electrodes on the peripheral area has a first opening and corresponds to one second auxiliary electrode extending to the corresponding first opening with a second distance from an inner wall of the corresponding first opening to a periphery of the corresponding second auxiliary electrode, and the second electrode in the same electrode set on the peripheral area has a plurality of second openings and corresponds to one first auxiliary electrode extending to the corresponding second opening with a first distance from an inner wall of the corresponding second opening to a periphery of the corresponding first auxiliary electrode.

12. The touch panel as claimed in claim 11, wherein the first distance and the second distance are respectively between 5 micrometers and 150 micrometers.

13. The touch panel as claimed in claim 10, wherein a shape of the first auxiliary electrodes and a shape of the second auxiliary electrodes comprise a stripe shape, a zigzag shape, or a meander shape.

14. The touch panel as claimed in claim 10, wherein the first auxiliary electrodes and the second auxiliary electrodes are respectively formed of a plurality of continuous V-shaped patterns, a plurality of continuous L-shaped patterns, a plurality of continuous reversed L-shaped patterns, or a plurality of continuous arc-shaped patterns.

15. The touch panel as claimed in claim 10, further comprising:
a plurality of third auxiliary electrodes, disposed on the light-transmission area and the peripheral area of the substrate, wherein two opposite ends of the second electrode in each of the electrode sets respectively connect to one of the third auxiliary electrodes, and the third auxiliary electrodes extend to the first electrodes in the same electrode set and generate capacitive sensing with the first electrodes.

16. The touch panel as claimed in claim 15, wherein a shape of the third auxiliary electrodes comprises an L-shape.
